(19) United States
(12) Patent Application Publication
(10) Pub. No.: US 2005/0079966 A1
(43) Pub. Date: Apr. 14, 2005

(54) Positioning apparatus for container forming machine

(76) Inventors: James Moshier, Reedley, CA (US); Dan Djokovic, Reedley, CA (US); Dan Nourian, Reedley, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 10/682,188

(22) Filed: Oct. 8, 2003

(51) Int. Cl. B31B 1/12

(52) U.S. Cl. 493/123

(57) ABSTRACT

The present invention provides an apparatus for use in a container forming machine that alters the path of a partially-formed container in a particular direction while independently rotating the partially-formed container itself to a selected angle or position. The apparatus may be incorporated into any container forming machine as an alternative to the traditional unidirectional conveying means. In one embodiment, the apparatus of the present invention allows the path of container formation inside the machine to double back against itself in a U-turn (180 degrees), thereby reducing the overall footprint of the machine, while at the same time positioning the partially-formed container for further formation activity by rotating the container itself only 90 degrees. In another embodiment, an apparatus is provided that raises or opens the partially-formed container as it travels along the altered path.

### BACKGROUND OF THE INVENTION

1. Field of the Invention

The present invention relates to machines for forming containers from flat paperboard blanks, and more particularly to an apparatus in such a machine that allows the path of container formation inside the machine to be altered (turned) so as to optimize the overall dimensional profile of the machine, while also rotating containers being formed to a desired angle for further processing in the machine.

2. Description of the Prior Art

In the packaging industry, it has been found most efficient and otherwise effective to employ paperboard containers for the packing, shipment and storage of commodities such as fresh fruit, fresh vegetables and meat, pre-packaged goods (e.g. cans of soup, bottles of beverages, jars of jelly, bags of rice, cartons of cereal, etc.) as well as a wide assortment of other products. Paperboard containers are comparatively inexpensive, light in weight, sufficiently strong for the prescribed usage and disposable at the ultimate destination.

Numerous paperboard containers and designs have been developed over the years along with machines for forming containers from such materials. These containers are typically constructed of a corrugated material which may be single face corrugated, single wall (double-faced) corrugated, double wall corrugated, triple wall corrugated, etc. Containers may also be made of other paperboard products including, without limitation, container board, boxboard, linerboard, and cardboard. Containers made from these materials can be produced in a variety of shapes and sizes suited to the specific prescribed uses intended. Such containers are unusually strong and durable for their cost and weight and thus are excellently suited to serving a multitude of uses. Typically, the manufacturers of such containers produce them in flattened, blank type configurations. These are sold in bulk to users that employ container forming machines to form, or erect, the containers for use. Such users may, for example, be companies that pack and sell, or distribute, any of the aforementioned commodities.

A conventional container forming machine typically receives the container blanks in bulk in a hopper, or magazine. During operation, the machine feeds each blank in succession along a path of travel, applies adhesive at pre-selected locations thereon, folds the container blank along preformed score lines and into designed container configurations, compresses portions of the container so that the adhesive adheres to retain the container in the designed configuration and finally discharges the container for use in packing the commodities involved. Such packing is normally also performed on an entirely automated basis by other equipment. It is essential in such container forming machines that the containers be formed and discharged at a high rate of speed to produce the volume of containers required during the packing operation.

Traditional container forming machines erect containers along a unidirectional path. A stack of flat container blanks is generally loaded onto the front end of the machine. The blanks are then individually removed from the stack, and fed into the machine. Mandrels, plows and/or actuators fold and form the blanks into containers while adhesives are applied to bond surfaces together. The containers may or may not then be loaded with goods, and the containers then exit from the opposite end of the machine. Many different container styles and types have been developed over the years, each being optimally suited for one or more particular products or industries. As the designs containers have advanced, the designs of container forming machines have also become increasingly more sophisticated. In many instances, the addition of multiple desirable features on such machines transforms the machines into large behemoths requiring considerable floor space within a warehouse or packing facility for proper operation.

U.S. Pat. No. 3,729,887 discloses one such device having three stations: a container formation station, a loading station, and a sealing station. Such a device requires significant floor space, since its length must accommodate all three stations adjacent to each other. Additional stations and processes will increase the physical dimensions of such a device.

Various machines have been developed to alter the formation or loading path of a container blank. For example, U.S. Pat. No. 5,100,369 discloses a right angle turn in the conveying means, and a means for moving containers around the turn using special fitments that are attached to the container tops as the containers travel through the machine. These fitments are engaged by corresponding fitments in the machine which carry the containers around the turn. U.S. Pat. No. 6,537,187 discloses another machine having a turning mechanism utilizing a rotatable distributor disk, a primary conveying means, pulleys, and a secondary conveyor. Critical timing and interaction between these components is required for the container to properly make the turn.

Unfortunately, neither of these machines effectively utilizes its floor space. Although the right angle turn in the '369 device decreases its overall length, such a decrease is accompanied by an increased width. This actually results in a greater floor space requirement, since the empty rectangular floor space partially bounded by the conveying means has limited uses. Specifically, usage of such empty space is limited by safety concerns, the need for routine service of, and access to, the device, and the availability of other devices that would fit within the empty space. The '187 invention also fails to effectively utilize its floor space, in that a significant portion of the central area bounded by the conveying means is occupied by the components necessary to effect the turn and rotation of the containers. The remaining unused floor space is not easily accessible from outside the bounded conveying means, and is therefore wasted. Furthermore, neither device provides both a simple and universal means for affecting the container rotation itself. The '369 invention functions only when used with containers having irregularly-shaped or angled fitments. An alternatively shaped fitment shape would prevent the container from rotating while being grasped by machine, and using symmetrical or circular fitments would creating a risk that the containers would not be properly rotated during the turn. Moreover, the '369 invention permits only a ninety degree counterclockwise rotation in the container facing—there is no means for adjusting the amount of rotation, or to prevent the container from rotating at all. The '187 invention requires precise timing between the interaction of a central distributor disk, pulleys and a secondary conveyor belt to perform the turn, complicating the operation of the invention and increasing maintenance times and expenses.

It is therefore desirable to provide a container forming machine that is capable of performing a variety of formation, loading and/or sealing operations on a container blank having minimal physical dimensions (a minimal footprint), so as to permit the performance of such operations in locations having little available floor space. It is also desirable to provide a machine or sub-assembly that minimizes wasted floor space by making full and efficient use of the floor space utilized by the operable machine components or stations. It is also desirable to provide a machine or sub-assembly having simple, universal and adjustable means for rotating and positioning containers during the formation process.

### SUMMARY OF THE INVENTION

The present invention provides an apparatus for use in a container forming machine that alters the path of a partially-formed container in a particular direction while rotating the container itself to a selected angle or position. The apparatus may be incorporated into any container forming machine as an alternative to a traditional unidirectional conveying means. In one embodiment, the apparatus of the present invention allows the path of container formation inside the machine to double back against itself in a U-turn (180 degrees), thereby reducing the overall footprint of the machine, while at the same time positioning the partially-formed container for further formation activity by rotating the container itself only 90 degrees.

The invention generally comprises of a horizontal base plate with rounded edges supporting a plurality of outwardly extending rotatable support arms, and a motorized mechanism for driving the support arms around the perimeter of the base plate. Each support arm has an end that includes a head supporting one or more suction cups. The suction cups are connected to a switchable vacuum source, which permits the suction cups to securely grasp a surface of a container upon contact when the vacuum is activated, and release it when the vacuum is discontinued. The support arms are also independently rotatable around their y-axes. This permits the suction cups to fully grasp the container and maintain this grasp while the container travels around a turn. This also permits the invention to rotate the front face of the container in any number of degrees, simply by rotating the support arm at a different speed relative to the speed and direction of the overall turn.

It is to be appreciated that any turn angle in the path through the machine may be accommodated simply by altering the length of the turn, the rotation speed of the support arms and/or the release timing of the suction cups. This permits a turn angle of anywhere from a few degrees to 180 degrees. It is also to be appreciated that the container rotation itself may be adjusted simply by limiting rotation or modifying the rotation speed of the support arms relative to the turn or turn speed of the turn conveyor.

In use, the invention may be installed inside a container forming machine to impart a turn in the path of formation of containers through the machine. A flat container blank is fed into the machine and partially or fully erected using mandrels, plows, actuators or other known formation means. Preferably, the body of the container has been formed prior to arrival at the turning mechanism of the present invention. As the container approaches the apparatus of the present invention to make a turn, a support arm is positioned to meet the container, the arm having one or more vacuum suction cups facing outward. Vacuum suction is applied to the partially formed container as it contacts the suction cups, allowing the invention to grasp the container. The support arm then begins to travel around the curved perimeter of the base plate. The amount and length of this turn is dictated by the path of the support arm around the base plate, which is determined by the size and curvature of the base plate. Such a path may be only a few degrees for a small turn, or a full 180 degrees for a U-turn.

During the turn around the base plate, the container may or may not be rotated. It is to be appreciated that if the support arm holding the container simply travels around the turn without independent rotation, the front face of the container will be turned the same amount as the turn itself. For example, in a 90 degree clockwise turn, the front of a container that was facing south now faces west. However, the position of the container may be changed by rotating the end of the support arm along its y-axis. Thus, if the end of the support arm is rotated at a speed that is equal to, but opposite from, that of the support arm itself around the base plate, the front of the container will continue to face in the same direction throughout the turn. In such a case, for example, in a 90 degree clockwise turn, the front of the container that started the turn facing south still faces south after the turn is completed. If, on the other hand, the end of the support arm is rotated faster than the arm itself travels around the base plate, the front of the container may be turned more than the overall turn. Likewise, if the end of the support arm is rotated slower than the arm itself travels around the base plate, the front of the container may be turned less than the overall turn. The difference between the rotation speed and the speed around the base plate governs the extent of the change. Such a change may be as little as a few degrees, to as much as 360 degrees. When the container arrives at the end of the turn, the vacuum suction is discontinued, releasing the container and allowing it to travel onward for further processing.

Accordingly, it is possible to use the present invention to minimize the floor space requirements of any container assembly device by providing up to a 180 degree turn in the path of assembly. A 180 degree turn provides the greatest potential reduction in the physical dimension of the overall machine, in that instead of a single lengthy straight path of formation, the path doubles back against itself making for a more compact machine. The floor space requirements may be further optimized using several 180 degree turns within the same conveying means. Finally, the use of a single base plate with multiple rotatable support arms provides improved throughput as well as a simple and effective alternative to earlier inventions.

It is therefore a primary object of the present invention to provide an apparatus for use in a container forming machine that alters the path of container formation for optimal results.

It is also a primary object of the present invention to provide an apparatus for use in a container forming machine that alters the path of container formation so as to minimize the physical dimensions of the overall machine, and permit the formation of containers in locations having minimal available floor space.

It is also a primary object of the present invention to provide an apparatus for use in a container forming machine that alters the path of container formation while simultaneously rotating the containers being formed to a desired position.

It is a further object of the present invention to provide an apparatus for turning the path of formation in a container forming machine which minimizes unused floor space by making full and efficient use of the floor space bounded within the container conveying means.

Finally, it is also an important object of the present invention to provide an apparatus for changing the path of formation in a container forming machine which is relatively simple to implement, adjust and maintain.

Additional objects of the invention will be apparent from the detailed description and the claims herein.

### BRIEF DESCRIPTION OF THE DRAWINGS

FIG. 1 is a left side perspective top view of an exemplary forming apparatus used with the present invention, depicting a container blank passing through alignment, adhesion and formation processes.

FIG. 2 is a right side perspective top view of the apparatus shown in FIG. 1.

FIG. 3 is an enlarged perspective view of an embodiment of an alignment and adhesion apparatus.

FIG. 4 is a left side perspective view of a container formation path and apparatus showing a blank passing through formation, alignment and adhesion processes.

FIG. 5 is a set of sequences of views of a container blank showing its initial formation stages from perspective, top and end views.

FIG. 6 is a set of sequences of views of a container blank showing additional formation stages from perspective, top and end views.

FIG. 7 is perspective view of a container formation path and apparatus showing formation, alignment and adhesion processes.

FIG. 8 is a perspective top view of an embodiment of the turning apparatus present invention.

FIG. 9 is a perspective bottom view of the embodiment of FIG. 8.

FIG. 10 is a top plan view of the embodiment of FIG. 8.

FIG. 11 is a perspective view of a dunnage removal apparatus.

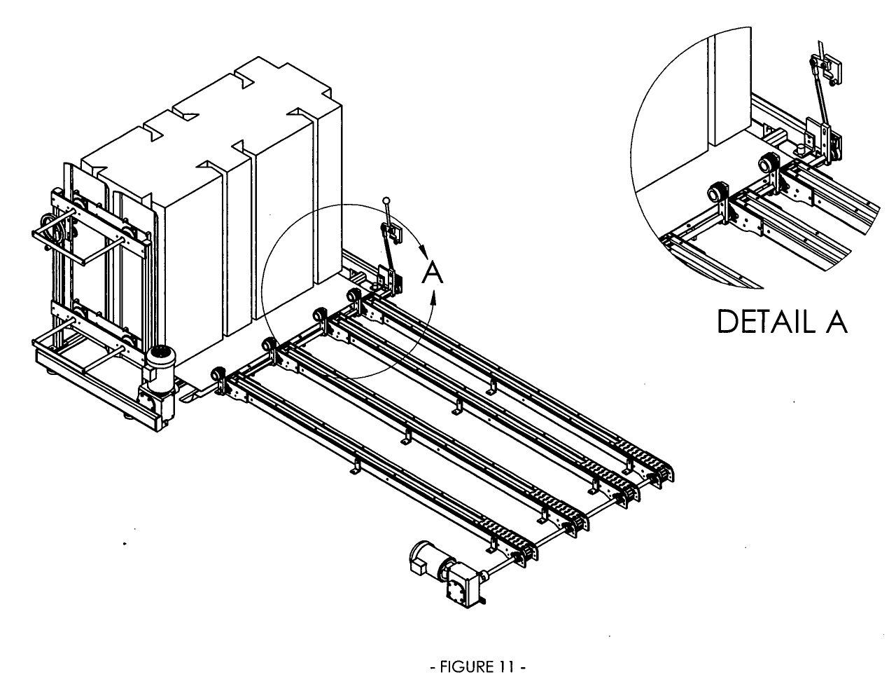

FIG. 12 is a view of a representative container containing products.

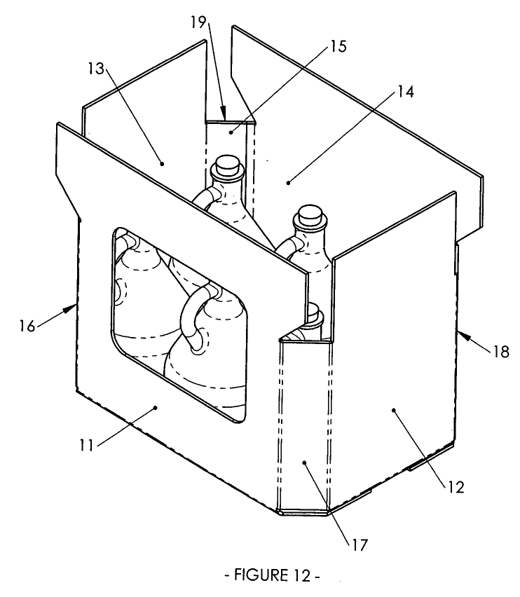

### DETAILED DESCRIPTION

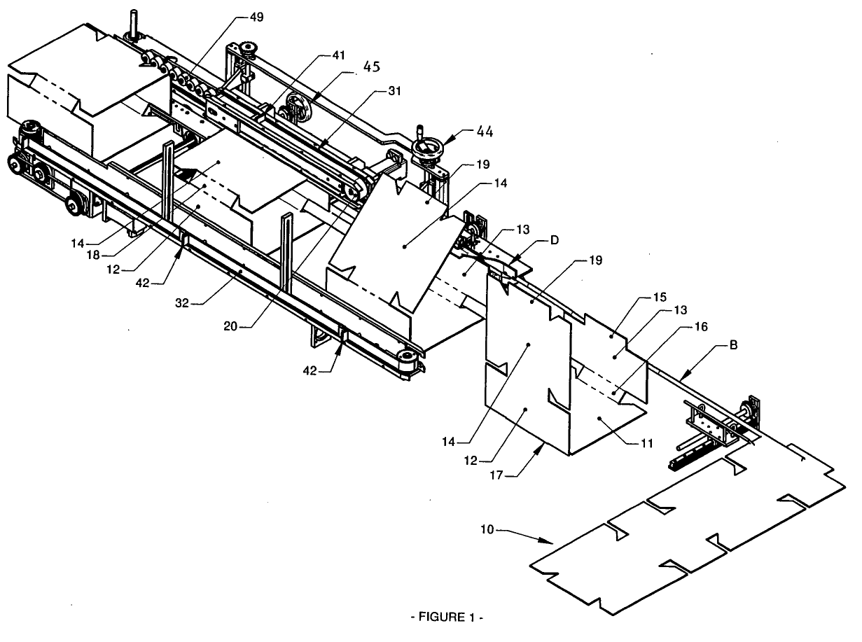

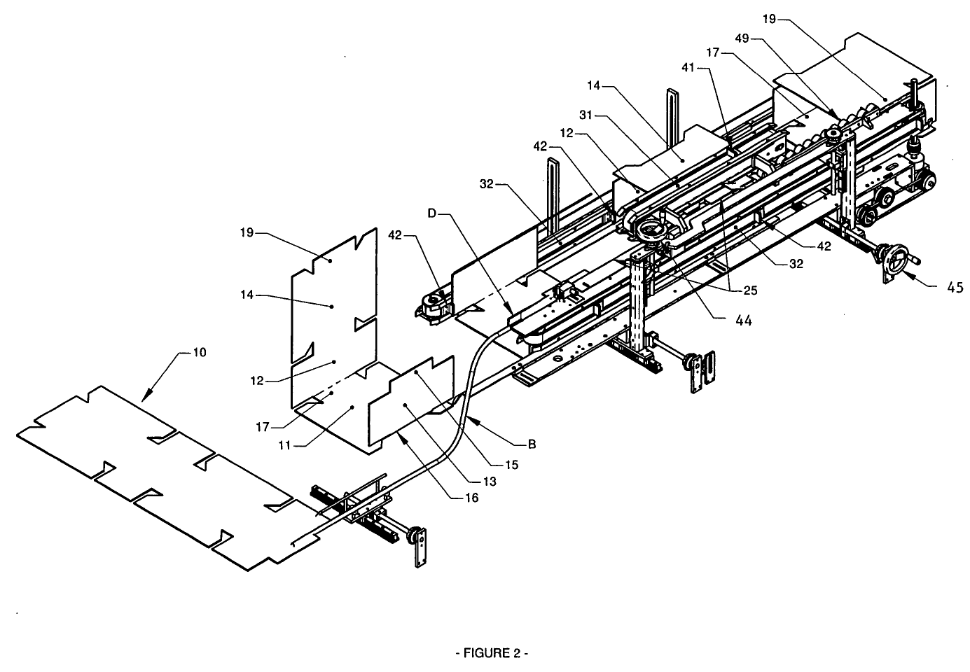

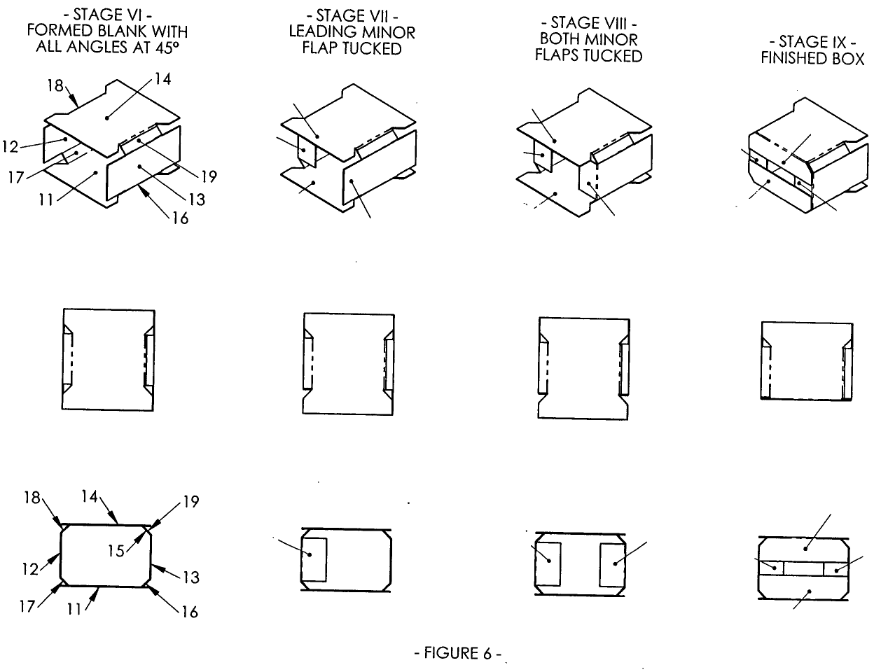

Referring to the drawings wherein like reference characters designate like or corresponding parts throughout the several views, and referring particularly to FIG. 1 it is seen that the illustrated formation apparatus includes a series of plows and guides which bend, fold and wrap the plurality of panels of a container blank 10 to form the body of a container as the blank 10 is fed laterally through a forming machine. It is to be appreciated that the blank 10 illustrated in FIGS. 1-2 and 4-6 has eight panels such that it forms an octagonal container body, but that a blank 10 having any number of panels (e.g., 4-12, or more) could also be formed in a similar manner with minor adjustments to the plows and guides of the machine.

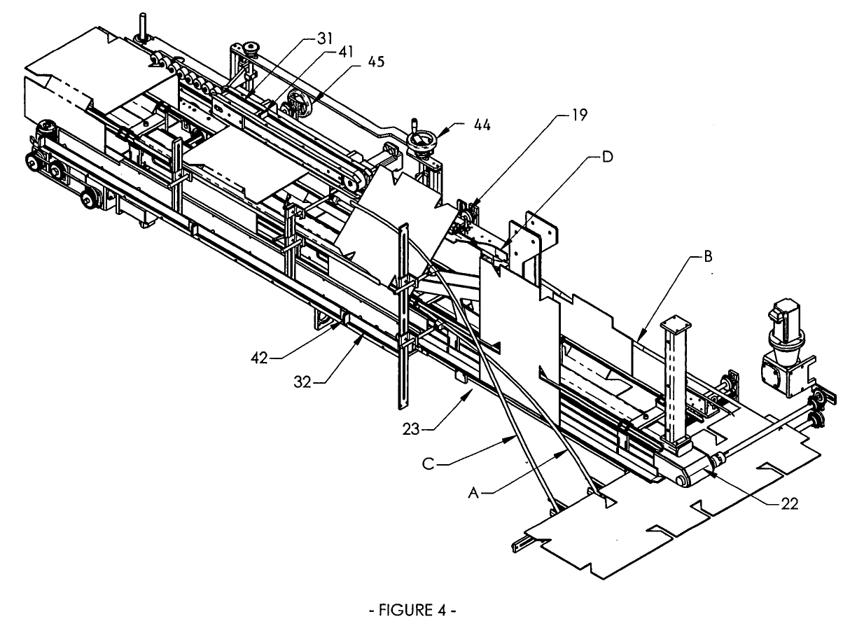

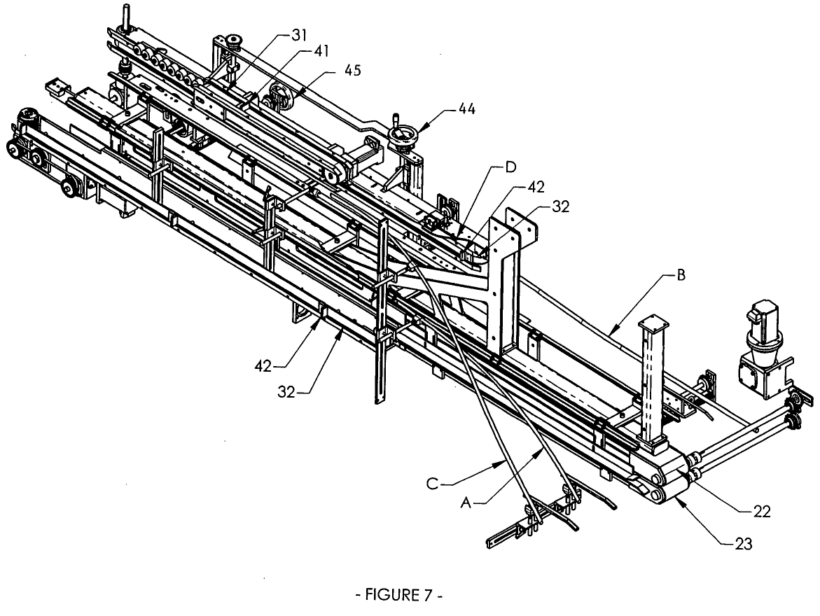

In the example illustrated in FIG. 4, blank 10 is urged forward laterally through the machine by the primary conveyors 22. The exemplary embodiment of FIGS. 4 and 7 illustrates primary conveyors 22 as a pair of pinch belts 22 and 23, however it is to be appreciated that any appropriate conveyance means may be used including without limitation, belts or chains having adjustably removable cleats located at appropriate intervals thereon. Pinch belts are preferred over cleats as the primary conveyors 22 because pinch belts avoid damaging the blank as it encounters frictional resistance from the forming plows and guides. Such frictional resistance could cause cleats to impart dents or deformities to the blank, whereas pinch belts allow some slippage of the blank 10 without damaging it, while maintaining throughput of blanks through the machine. This slippage is compensated for in an alignment section described more fully below. As it is moved through the machine, the container blank 10 encounters a series of inner and outer plows and guides (A-D) which bend, fold and wrap the various panels of the blank in a circular or funnel fashion.

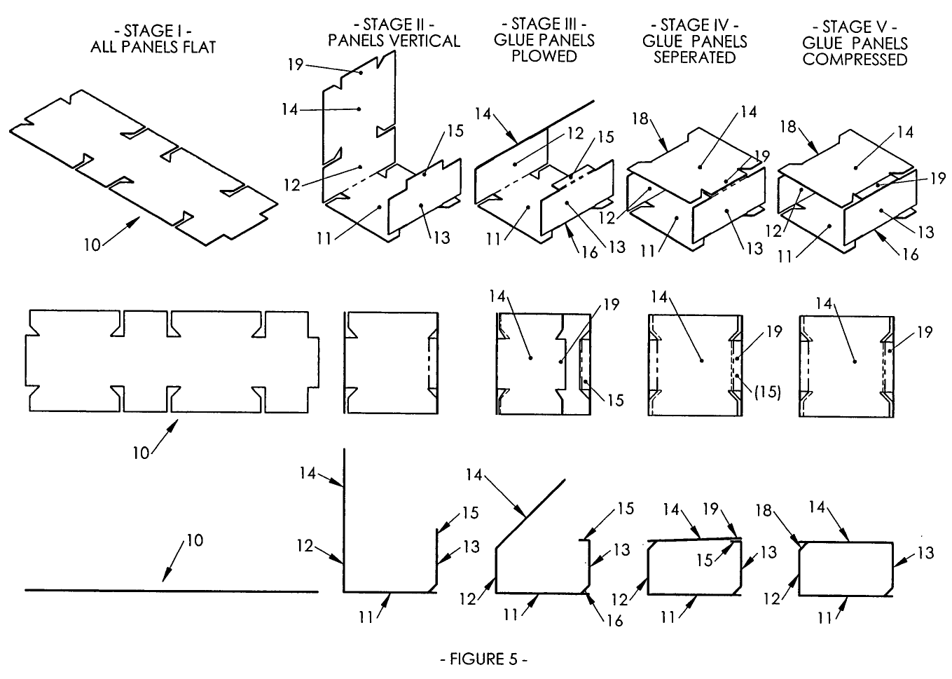

The various stages of folding experienced by this exemplary blank are illustrated in FIG. 5. First, side panel 12 including attached top panel 14 is initially bent upward to a generally vertical position by side plow bar A. At about the same time, second side panel 13 is also bent into a generally vertical position by side plow bar B. See FIG. 4, and Stage II of FIG. 5. Next, plow bar C folds top panel 14 down to an angled position. See FIG. 4. At about the same time, an intermediate end panel 15 attached to side panel 13 is bent from vertical to horizontal by plow bar D. These two folds are shown at Stage III of FIG. 5. These major folds are preferably accomplished while blank 10 is being propelled only by the primary pinch belt conveyors 22 so as to avoid any potential damage to blank 10 that may result from cleats pressing against blank 10 during the frictional resistance imparted by plows A-D.

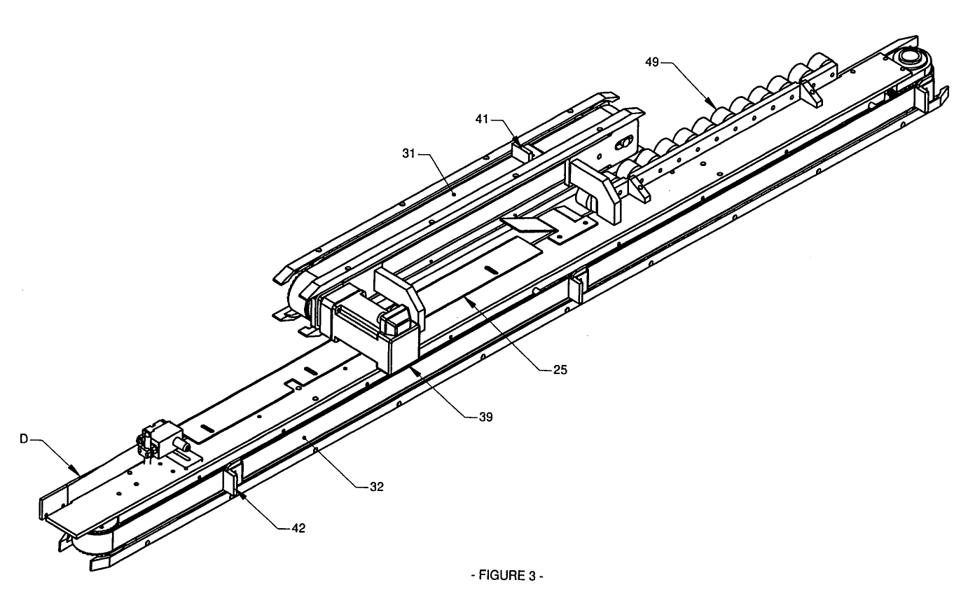

In the illustrated embodiment, as blank 10 continues moving forward it is handed off to a set of one or more secondary conveyors 32. In the exemplary embodiment illustrated in FIGS. 1-4 and 7, it is seen that these secondary conveyors 32 are provided on either side of the path of the blank 10 defined by the primary conveyors 22. Secondary conveyors 32 are provided with adjustably positionable cleats 42 for engagement with the now up-folded side panels 12 and 13 of blank 10. The positions of cleats 42 on conveyors 32 may be adjusted according to the size, spacing and style of the particular container blanks 10 introduced into the machine. If multiple secondary conveyors 32 are used, each of cleats 42 is synchronized on its respective conveyor 32 so that each cleat 42 engages the back edge of its respective panel on the same plane so as to maintain all of panels 11-13 in alignment with each other.

Top panel 14 (with attached intermediate panel 19) is next folded to a generally horizontal position as shown at Stage IV of FIG. 5. This activity results in the position of intermediate panel 19 attached to top panel 14 being located in a spaced relationship above intermediate end panel 15 of panel 13. These two intermediate panels (19 and 15) will eventually be adhered together to form a continuous body or wrap of the formed container. It is to be appreciated that blank 10 may have any number of panels (in the illustrated example, there are eight such panels), and that plows and guides may be added, removed and/or adjusted according to the given number of panels so that the first and last panels (in the illustrated example, intermediate panels 15 and 19) are positioned above each other in a spaced relationship prior to adhesion. It is also to be appreciated that the primary and secondary conveyors, and any cleats located thereon, may also be adjusted according to the size, style and spacing of the particular container blanks 10 introduced into the machine.

Between stages I-IV, the friction between plow bars A, B, C and D against respective panels 12, 13, 14 and 15 may cause panels 14 and 19 to drag slightly such that they lag behind side panels 12 and 13 which are being propelled forward by cleats 42 on secondary side conveyors 32. The larger the container blank, the larger the panels, the greater the surface area and distance from the first panel to the last panel, and the more pronounced the potential frictional lag of the most remote panels (e.g. 14 and 19) from the panels closest (e.g. 12 and 13) to the conveyors 22 and 32. For some container blanks, this lag may be as much as two inches. Because of this friction, it is important to assure that main panels 11-14, and particularly the intermediate panels 15 & 19 are properly aligned before they are adhered to each other. The position of panel 11 is not of concern in the illustrated embodiment since it is located between panels 12 and 13 which are being moved synchronously by aligned cleats 42 on secondary conveyors 32. However, this may not necessarily be the case in a different embodiment with different conveyors contacting different panels.

The adhesion and alignment is accomplished by first applying longitudinal beads or strips of adhesive to the top of lower panel 15 (or the bottom of upper panel 19, or both) while keeping lower panel 15 spatially separated from upper panel 19 until alignment occurs. This separation is accomplished using a separating member 25 positioned between panels 15 and 19 that extends for a short distance along the path through the machine, after plow D has bent panel 14 down. Over this critical span that includes but extends beyond member 25, one or more additional alignment devices 31 are provided to engage the trailing edge(s) of one or more of the now bent panels (e.g. 12, 13 and/or 14 in the illustrated embodiment) of blank 10 to bring them into alignment with the back edge of the remaining panels (e.g. bottom panel 11).

In the illustrated embodiment, one or more alignment conveyors 31 are provided along the critical span of the longitudinal path of the container blank 10 through the machine including and extending beyond separating member 25. Each alignment conveyor 31 is a continuous motor-operated belt that is provided with a plurality of adjustably positionable cleats 41 located thereon at spaced intervals. These intervals may be the same or different from those of cleats 42 on secondary conveyors 32. In the illustrated embodiment, alignment conveyor 31 is mounted above the path of the container blank so that each cleat 41 engages the trailing edge of a top panel 14. Additional conveyors 31 may also be provided along the same critical section of the longitudinal path, each additional alignment conveyor 31 having, respectively, a plurality of cleats 41 located thereon at the same spaced intervals. It is to be appreciated that one or more alignment conveyors 32 may be provided at any suitable location along the path of blank 10 in order to engage any panels of the blank 10 that may potentially be trailing as a result of frictional resistance discussed above.

Each alignment conveyor 31 is independently operable from the primary 22 and, if used, secondary conveyors 32. When multiple alignment conveyors 31 are used, they are synchronized with each other. Alignment conveyors 31 do not always operate at the same speed as primary and secondary conveyors 22 and 32. In the illustrated embodiment, a single alignment conveyor 31 is provided in a preferred location above the path of container blank 10. After blank 10 has been folded as described in stage IV, after adhesive has been applied, and while panels 15 and 19 are being held apart by member 25, the alignment conveyor(s) 31 come into use.

Alignment conveyors 31 pause briefly while the trailing edges of panels 12 and 13 are moved forward by secondary conveyors 32 to a position where those trailing edges (and cleats 42) have moved a short distance past the beginnings of the alignment conveyors 31. This delay is provided to compensate for the possible lag of panel 14 caused by the frictional resistance described previously, and allows potentially lagging panel 14 to also move past the beginnings of the alignment conveyors 31. Once this position is reached (i.e., cleats 42 have traveled a short distance past the beginnings of alignment conveyors 31), alignment conveyors 31 are activated and initially move more quickly than primary and secondary conveyors 22 and 32 in order to “catch up” with them. Servo or other similar motors may be used to accomplish this movement. This quick movement causes cleat(s) 41 to engage the trailing edge(s) of any potentially lagging panel(s) (e.g., panel 14) and bring them into alignment with the remaining panels of the blank 10. Once alignment cleats 41 have caught up with and are in alignment with secondary conveyor cleats 42, the lagging panel(s) are in alignment with the other major panels of the blank 10, and the speed of alignment conveyors 31 is reduced to match that of secondary conveyors 32. In the illustrated embodiment, panels 15 and 19 are now directly above/below each other.

Once alignment has been achieved, panels 15 and 19 move forward past the termination of separation member 25, and encounter a compression mechanism on the path. This compression mechanism may take any appropriate form (such as rollers 49 in the illustrated embodiment) which compresses intermediate panel 19 against intermediate panel 15 so that the adhesive between these panels joins them firmly together. This adhesion does not occur until all major panels of the container blank are in alignment, transforming the container blank into a large open sleeve or wrap made up of multiple adjoining panels.

In the illustrated embodiment, first and last panels 15 and 19 are maintained in a parallel, generally horizontal position during the alignment and compression operations so as to assure proper and complete adhesion. However, the machine may be set up such that the first and last panels are maintained in some other position (vertical, angled, etc.) during alignment and compression operations, so long as they are parallel to each other. After adhesion, and during later formation processes these panels may then be bent at any appropriate angle.

The positions of alignment conveyors 31 and pressure rollers 49 are adjustable so as to accommodate different sized container blanks 10. In the illustrated embodiment, the carriage assembly supporting conveyor 31 and rollers 49 may be adjusted upward or downward by rotating adjustment screw 44, and it may be rotated forward or backward using adjustment screw 45. The amount of adjustment will depend upon the size and shape of the container blank 10 to be used.

It is important to recognize that there is a critical point along the formation path through the machine at and after which the one or more alignment devices 31 should make contact with panels of the container blank 10. The major folds of the container blank 10 must be accomplished before this point, and sufficient space allowed for any lagging panels to also pass the point before alignment devices 31 are activated. Alignment devices 31 must first wait until all of the panels of blank 10, including any that may lag behind because of the friction of the formation process, have moved beyond the crucial point. This generally means waiting longer than the time necessary for the panels immediately adjacent to the secondary conveyors 32 to reach the critical point, the amount of delay (space) depending upon the size and shape of the particular container. The remote panels of larger container blanks with larger panels and more surface area (i.e., generating more frictional resistance) are likely to have a more pronounced lag than those of smaller containers with smaller panels and less surface area. When sufficient time or movement has occurred to assure that all panels have passed the crucial point, the alignment devices 31 are activated and quickly “catch up” with the secondary conveyors 32, and in the process they bring the lagging panels of the container blank 10 into alignment with the other panels of the blank.

It is to be appreciated that the “catch up” process of the alignment conveyors may be accomplished using a variety of different devices, and that one or more of such devices may be deployed at any suitable position or location along the path of formation, including without limitation, above, below, at one or more comers, or along one or more sides of said path. In one alternative embodiment, one or more pneumatic or hydraulic cylinders may be utilized in conjunction with one or more conveyors. In this embodiment, once all panels of the blank 10 have passed the critical point, the cylinder is activated which causes an associated contact element to be quickly extended out in parallel with the path of blank 10 such that the element pushes against a frictionally trailing panel of the blank 10. This movement causes the trailing panel to catch up with the remaining panels of the blank, at which point an additional conveyor engages this panel to keep it in alignment.

The “catch up” alignment device may alternatively take the form of one of numerous other embodiments that cause the necessary lurch which brings the remote panel into phase/alignment with the remaining panels, such as: a timing belt, a pulsing servo motor attached to a conveyor, a powered wheel and rail system, pinch belts, bottom rollers with tabs, adjustably cleated chains or belts (as illustrated), suction cups along the path, a drum system, or the like.

Once the container blank 10 has been folded around itself with the overlapping panels adhered to each other, further activity is required before the container is completely formed. If this activity were to continue along a straight path, that path would be lengthy, resulting in an elongated formation machine. Such a large machine would require considerable floor space that may not always be available. Accordingly, in order to reduce the size of the footprint of the machine, the container formation path inside the machine makes a 180 degree turn before formation continues. This internal U-turn allows the overall machine to be more compact, making it possible to fit into a smaller space. It is to be appreciated that while the following discussion refers to a 180 degree turn, a turn of any number of degrees (from 1 to 360) may be accomplished using the apparatus of the present invention.

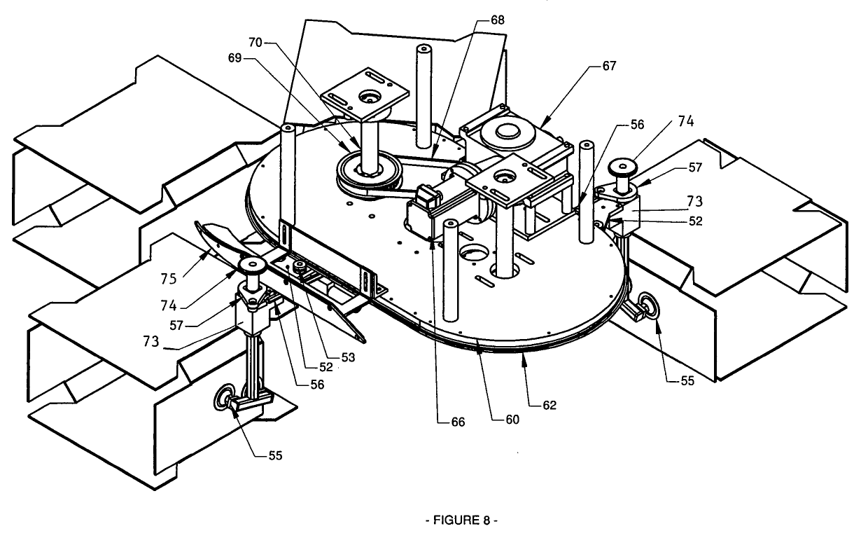

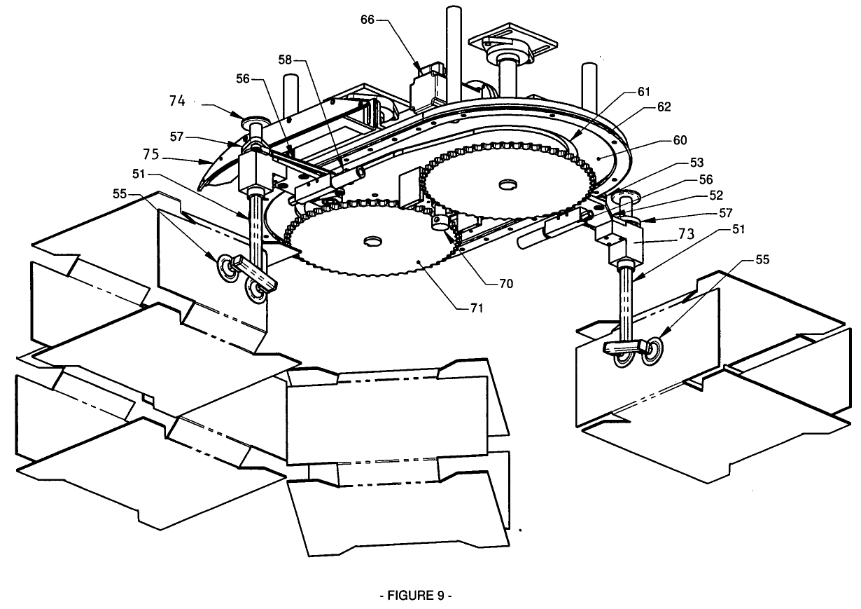

Referring to FIGS. 8-10, in the illustrated embodiment a U-turn may be accomplished through the use of a plurality of outwardly extending moveable support structures 52, each structure 52 supporting a pivotally mounted rotatable arm 51 which, in turn, supports one or more vacuum suction cups 55 for temporary engagement with a panel (e.g., 12) of each container blank 10. Arm support structures 52 are provided at spaced intervals on a track 62 located on the underside of a base plate 60 around which the turn (in this case, a U-turn) is made. The spacing of structures 52 is adjustable according to the size of the container blanks 10 and the frequency of their arrival. Base plate 60 and track 62 may have a circular, oval, elliptical or other similar shape so as to allow the outwardly extending structures 52 to turn through up to 180 degrees as they travel around one end of the track 62, taking a container blank 10 with them. The container blank is eventually disengaged, and the structures 52 revolve around the balance of the track 62 to start the cycle over and bring another container blank 10 around the turn. This overall structure is sometimes referred to herein as a turret.

It is to be appreciated that imparting motion to the arm support structures 52 to cause them to travel along track 62 may be accomplished in a variety of different ways using different mechanical configurations. For example, the arm may be linked to a chain or timing belt, to a direct drive device, a linkage and cam, etc. In the preferred embodiment shown in FIGS. 8-10, a motor 66 such as a servo motor, is provided on the upper surface of plate 60 with its operative shaft engaged with gears inside an adjacent gearbox 67. It is to be appreciated that different sets of gears (not shown) may be provided inside box 67 to modify the speed and strength of the motion imparted by motor 66 according to the requirements of the user. A belt or chain 68 extends from gearbox 67 to an upper sprocket 69 which imparts motion to shaft 70 which, in turn, rotates large lower sprocket 71. Another belt or chain 72 is provided for engagement between sprocket 71 and the base 50 of each of arm support structures 52.

In the illustrated embodiment, each support structure 52 includes one or more followers 53 which engage track 62 allowing structure 52 to travel along this track around and around plate 60. Each support structure 52 also includes a linkage made up of a first pivot 57 attached to one end of rotatable arm 51, a second pivot 58 attached to an inside edge of structure 52, and a linking member 56 connecting between pivots 57 and 58. Second pivot 58 also includes a track follower 59 (not illustrated) which follows an internal track or groove 61 on the underside of base 60. Internal groove 61 follows a path that is inside of and generally parallel to track 62. If groove 61 is parallel to track 62, then the rotation of container blank 10 will be the same as the revolution of support structure 52 around plate 60. However, the rotation of blank 10 may be altered by changing the course of groove 61 which, in turn, will cause arm 51 to rotate as a result of the interaction of pivots 57 and 58 on linking member 56, as described more fully below.

In the illustrated embodiment, container blank 10 is rotated 90 degrees while it revolves 180 degrees around the turn. The following is a description of this particular embodiment, it being appreciated that variations and modifications of such things as the length and curvature of track 62, the relative position of groove 61 in relation to track 62, the size and mounting position of linking member 56, among other things, can be made to impart a specific desired amount of turn and rotation of container blank 10.

The length of groove 61 is shorter than track 62 because it is located inside of track 62. In the illustrated embodiment, groove 61 deviates from an otherwise parallel course with track 62 in two different places. The first such deviation occurs after the first 90 degrees of travel along groove 61 (i.e. during rotation of support structure 52 through 91-180 degrees) following engagement of a container blank 10. The second deviation occurs during the last 90 degrees of rotation of support structure 52 as it completes a circuit around track 62 and prepares to engage another container blank.

The two exemplary deviations along groove 61 cause track follower 59 to cause pivot 58 to move which causes arm 51 to rotate two different times. In the first deviation, the path of groove 61 is changed so as to be closer to track 62. As follower 59 follows this deviation in groove 61, is pushes pivot 58 such that it extends rod 56 outward. This causes pivot 57 to rotate arm 51 in a clockwise direction (as viewed from the top). An opposite deviation is provided later in groove 61 where it travels back away from track 62. This later deviation causes arm 51 to rotate the same amount in the opposite direction.

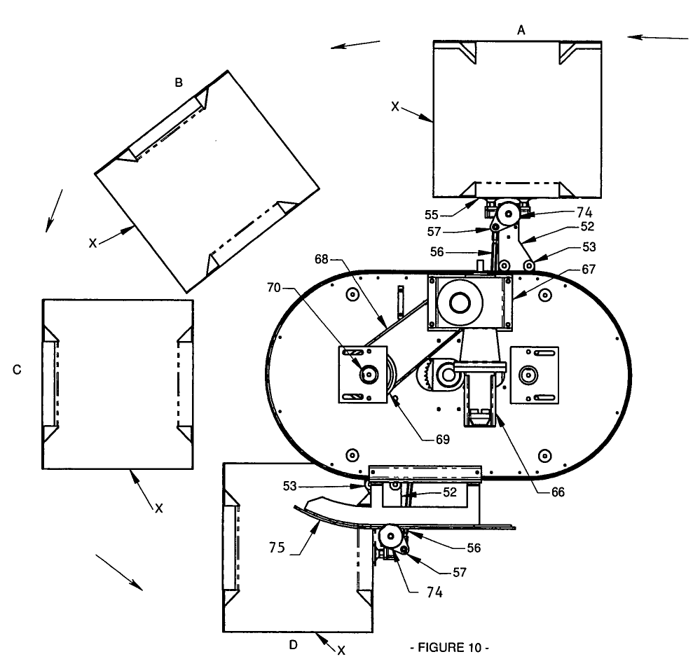

The first of the exemplary deviations in groove 61 has the effect of causing the attached container blank to only rotate 90 degrees while being taken through a turn of 180 degrees. This is illustrated in FIG. 10. First, suction cups 55 temporarily attach to a recently folded container blank 10 as shown in position A. The support structure 52 then follows path 62 in a counter-clockwise direction around plate 60 as shown by positions B and C. At position C, the container blank has traveled through 90 of the 180 degrees of the U-turn around plate 60. At this point (position C), groove 61 begins its deviation from track 62 causing the movement of linkage 56-57-58 and the clockwise rotation of arm 55. As support structure 52 travels counter-clockwise through the rest of the U-turn (91-180 degrees), arm 55 is rotating clockwise 90 degrees. These countervailing actions have the effect of freezing the rotated position of the container blank 10 while it is brought through the rest of the U-turn, as illustrated in position D, such that the open end X of container blank 10 is only rotated 90 degrees. When the turn is completed, the suction is disengaged releasing blank 10 for further processing. This allows for a mandrel to be conveniently inserted into open end X from the side to facilitate complete formation of the container from the blank.

The second exemplary deviation in groove 61 occurs after the container blank 10 has been released, as support structure 52 travels around the remainder of track 62 prior to picking up the next container blank. In this section of track 62, the path of groove 61 is changed so as to be farther away from track 62. As follower 59 follows this second deviation in groove 61, is rotates pivot 58 such that it pulls rod 56 inward. This causes pivot 57 to rotate arm 51 in a counter-clockwise direction (as viewed from the top), positioning suction cups 55 to pick up the next container blank 10 as support structure 52 begins another lap around track 62.

It is to be appreciated that other embodiments may be employed that have tracks 62 with different curvatures for different sized turns; that have grooves 61 with one or more deviations of varying degrees which result in differing amounts and/or directions of rotation imparted to the support arms 51; and combinations thereof.

In one embodiment of the invention, an additional structure is provided for opening up or raising the body of container blank 10, if desired. In many instances, the container blank that has been formed has more than four side panels (e.g. 6, 8, 10 or 12 panels), but during the initial stages of the formation process, less than all of these panels may yet have been shaped from blank 10 by the time blank 10 reaches the turning apparatus of the present invention. In such situations, it is beneficial to raise the container blank 10 so as to open it up and facilitate the shaping of these additional (often corners) panels. As a result, an embodiment of the present invention provides a mechanism that raises rotatable arm 51 as it travels with support structure 52 along path 60.

In this alternative additional embodiment, each of arms 51 is slidably (as well as rotatably) supported in box 73 of its respective support structure 52. An upper disc 74 is attached to the top of arm 51 above box 73. A tapered guide 75 is provided along path 60 in parallel with track 62 which is engaged by disc 74 as support structure 52 travels along path 60 holding a container blank. Guide 75 has a pointed proximal edge that fits under disc 74 when contact is first made. Guide 75 is shaped so that the edge that fits under disc 74 is angled upward which causes disc 74 (and arm 51) to be raised as disc 74 travels along guide 75. Eventually, the upper edge of guide 75 levels off at a height that is sufficient to raise or open the particular container blank 10 in use. It is to be appreciated that the size of guide 75 and the distance is raises disc 74 may be adjusted according to the requirements of the user and the size of particular container blank 10 in use.

It is to be appreciated that any suitable structure may be used to raise each of slidable arms 51 so as to raise and open container blanks 10. Blanks 10 may also be further opened by the placement of a plow 77 (not shown) along the path of formation that pushes the inside of container out (e.g. down) prior to or after blank 10 is raised by arm 51.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

1. An apparatus for conveying a partially-formed container blank through a turn in a path of formation comprising:
a. a platform having a continuous track around its perimeter;
b. at least one support structure movably engaged with said track for traveling thereon;
c. a rotatable arm pivotally attached to each support structure, each such arm supporting at least one variably operable vacuum attachment device for temporary engagement with a partially-formed container;
d. a continuous groove on said platform in the vicinity of said track; and
e. a movable linkage on said support structure, a first end of said linkage being pivotally attached to said arm, and an opposite end of said linkage being attached to a follower that fits into said groove wherein said linkage is capable of imparting rotation to said arm in response to the movement of said follower in said groove as said support structure travels along said track.

2. The apparatus of claim 1 wherein said variably operable vacuum device is a suction cup attached to a switchable vacuum source.

3. The apparatus of claim 1 wherein said vacuum attachment device temporarily engages a partially-formed container such that said container moves along a section of said track as said support structure travels thereon.

4. The apparatus of claim 3 wherein said linkage imparts rotation to said arm while said container is engaged to said vacuum attachment device.

5. The apparatus of claim 3 wherein said linkage imparts rotation to said arm for a portion of the time said container is engaged to said vacuum attachment device.

6. The apparatus of claim 1 wherein said rotatable arm is also slidably attached to said support structure allowing for reciprocating vertical movement, a second follower is attached to said arm, and a guide is provided along a section of said track for engagement with said second follower to raise and lower said arm as said support structure travels along said guide.

7. The apparatus of claim 6 wherein said second follower is in the form of a disc.

8. The apparatus of claim 6 wherein said guide is provided within the same section of said track where said vacuum suction means temporarily attaches to said container.

9. The apparatus of claim 1 wherein a motor is provided for driving said support structure around said track.

10. The apparatus of claim 9 wherein said motor is in communication with a continuous belt that drives at least one sprocket causing said support structure to travel around said track.

11. A method for changing the path of travel of a partially-formed container blank in a container forming machine comprising the steps of:
a. temporarily engaging said partially-formed container with at least one vacuum suction device, said suction device being attached to a support shaft, said shaft being attached to a support structure that travels along a continuous track;
b. moving said support structure such that said temporarily attached container travels along a section of said track;
c. disengaging said suction device from said container at the end of said section of track.

12. The method of claim 11 wherein said section of said track is curved.

13. The method of claim 11 wherein a groove is provided in the vicinity of said track, a moveable follower is provided in said groove, said support shaft is rotatable, and a movable linkage is provided between said follower and said support arm.

14. The method of claim 13 comprising the additional step of:
d. rotating said shaft in response to the movement of said follower in said groove as said support structure travels along said track.

15. The method of claim 14 wherein said rotatable shaft is also slidably attached to said support structure allowing for reciprocating vertical movement, a second follower is attached to the top of said shaft, and a guide is provided along a section of said track for engagement with said second follower.

16. The method of claim 15 comprising the additional step of:
e. raising and lowering said arm as said support structure travels along said guide.

17. The method of claim 16 wherein said guide is provided within the same section of said track where said vacuum suction means temporarily attaches to said container.

18. The method of claim 17 wherein said second follower comprises a disc.

19. A sub-assembly for a container forming machine that changes the path of formation of a partially-formed container blank as it travels through the machine comprising:
a. a platform means a continuous track around its perimeter;
b. at least one support means movably engaged with said track for traveling thereon;
c. a rotatable shaft means pivotally attached to each support means, each such shaft means supporting at least one variably operable vacuum attachment means for temporary engagement with a partially-formed container;
d. a continuous groove means on said platform means in the vicinity of said track; and
e. a movable linkage means on said support means, a first end of said linkage means being pivotally attached to said shaft means, and an opposite end of said linkage means being attached to a following means that fits into said groove means wherein said linkage means is capable of imparting rotation to said shaft means in response to the movement of said following means in said groove means as said support means travels along said track.

20. The sub-assembly of claim 19 wherein said rotatable shaft means is also slidably attached to said support means allowing for reciprocating vertical movement, a second following means is attached to said rotatable shaft means, and a means for guiding said second following means is provided along a section of said track to raise and lower said shaft means as said support means travels along said guiding means.
